(19) United States
(12) Patent Application Publication
(10) Pub. No.: US 2017/0188109 A1
(43) Pub. Date: Jun. 29, 2017

(54) METHOD AND ELECTRONIC DEVICE FOR SWITCHING VIDEO

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Min Li, Beijing (CN)

(21) Appl. No.: 15/243,822

(22) Filed: Aug. 22, 2016

Related U.S. Application Data
(63) Continuation of application No. PCT/CN2016/089073, filed on Jul. 7, 2016.

(30) Foreign Application Priority Data
Dec. 29, 2015 (CN) 201511019297.7

(51) Int. Cl. H04N 21/482; H04N 21/2187; H04N 21/2665; H04N 21/472; H04N 21/858; H04N 21/258; H04N 21/2668; H04N 21/45; H04N 21/84; H04N 21/81; H04N 5/268; H04N 21/658

(52) U.S. Cl. CPC H04N 21/4826; H04N 5/268; H04N 21/2187; H04N 21/2665; H04N 21/47202; H04N 21/6581; H04N 21/25891; H04N 21/2668; H04N 21/4532; H04N 21/84; H04N 21/8133; H04N 21/858

(57) ABSTRACT

The present disclosure discloses a method and an electronic device for switching video. The method comprises: displaying, in a playback process of a live video, a video-on-demand list corresponding to the live video in a live video playback interface according to a detected video-on-demand information viewing request; and jumping the live video playback interface to a video-on-demand playback interface corresponding to a target video item according to the target video item selected by a user from the video-on-demand list.

### CROSS-REFERENCES TO RELATED APPLICATIONS

This application is a continuation application of a PCT application No. PCT/CN2016/089073, filed on Jul. 7, 2016, which claims priority to Chinese Patent Application No. 201511019297.7, titled “METHOD AND DEVICE FOR SWITCHING VIDEO” and filed to the State Intellectual Property Office on Dec. 29, 2015, the entire content of both applications is incorporated herein by reference.

### TECHNICAL FIELD

The present disclosure relates to communication technologies, for example, relates to a method and an electronic device for switching video.

### TECHNICAL BACKGROUND

On-demand service refers to a service that a server plays audio and video streams according to a single user's program broadcasting requirements, the user may interact with a system to broadcast, pause, stop, fast forward or fast backward programs by means of a remote controller.

Live broadcast service refers to a service that a server initiatively pushes same audio and video streams to multiple users within a same time, and users can only watch programs instead of control program broadcasting.

During implementation of the present disclosure, inventors found at least following problems in related technologies: on-demand services and live broadcast services provided by many video players are independent of each other, if a user wants to watch a request program when watching a live video, the user needs to exit from a live broadcast interface and then selects and enters a video-on-demand playback interface to watch corresponding request program. Therefore an operation process is relatively cumbersome.

### SUMMARY

The present disclosure provides a method and an electronic device for switching video to implement fast switching between a live video playback interface and a video-on-demand playback interface.

In a first aspect, embodiments of the present disclosure provide a method for switching video, including:

displaying, in a playback process of a live video, a video-on-demand list corresponding to the live video in a live video playback interface according to a detected video-on-demand information viewing request; and

jumping the live video playback interface to a video-on-demand playback interface corresponding to a target video item according to the target video item selected by a user from the video-on-demand list.

In a second aspect, embodiments of the present disclosure further provide an electronic device for switching video, including:

at least one processor; and

a memory communicably connected with the at least one processor for storing instructions executable by the at least one processor, wherein execution of the instructions by the at least one processor causes the at least one processor to:

display, in a playback process of a live video, a video-on-demand list corresponding to the live video in a live video playback interface according to a detected video-on-demand information viewing request; and

jump the live video playback interface to a video-on-demand playback interface corresponding to a target video item according to the target video item selected by a user from the video-on-demand lists.

In a third aspect, embodiments of the present disclosure further provide a non-transitory computer-readable storage medium storing executable instructions that, when executed by an electronic device, cause the electronic device to:

display, in a playback process of a live video, a video-on-demand list corresponding to the live video in a live video playback interface according to a detected video-on-demand information viewing request; and

jump the live video playback interface to a video-on-demand playback interface corresponding to a target video item according to the target video item selected by a user from the video-on-demand list.

### DESCRIPTION OF DRAWINGS

At least one embodiment is illustrated by way of example, and not by limitation, in the figures of the accompanying drawings, wherein elements having the same reference numeral designations represent like elements throughout. The drawings are not to scale, unless otherwise disclosed.

FIG. 1 is a flowchart showing a method for switching video according to Embodiment I of the present disclosure;

FIG. 2 is a diagram showing an execution process of a method for switching video according to Embodiment I of the present disclosure;

FIG. 3 is a flowchart showing a method for switching video according to Embodiment II of the present disclosure;

FIG. 4 is a structural diagram showing an device for switching video according to Embodiment III of the present disclosure; and

FIG. 5 is a functional block diagram showing a hardware structure of a device according to Embodiment V of the present disclosure.

### DETAILED DESCRIPTION OF EMBODIMENT

The following describes in detail the technical solution of the present disclosure with reference to the accompanying drawings and embodiments. It is to be understood that embodiments set forth herein are merely intended to interpret the present disclosure and are not intended to limit the present disclosure. In addition, it should be noted that for ease of description, drawings merely show parts related to the present disclosure instead of all parts.

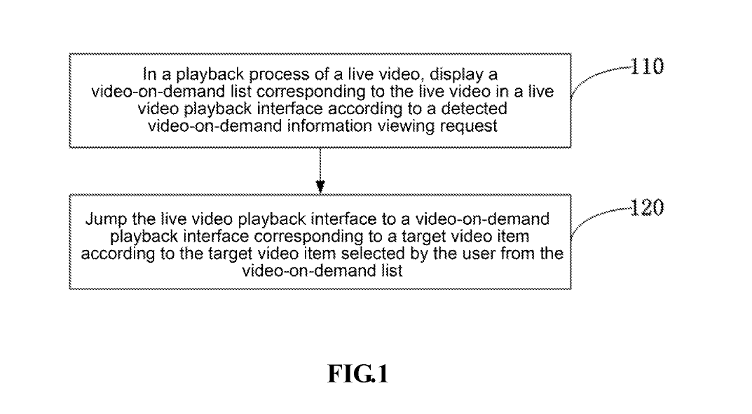

FIG. 1 is a flowchart showing a method for switching video according to Embodiment I of the present disclosure. This embodiment may be applied to video switching, the method may be executed by an device for switching video, and the device may be implemented by means of hardware and/or software, and generally may be integrated into a terminal device (for example, a smart television, a desktop computer or a tablet computer and the like) for playing a live or on-demand video. Referring to FIG. 1, the method for switching video provided by this embodiment includes following steps.

In Step 110, in a playback process of a live video, a video-on-demand list corresponding to the live video is displayed in a live video playback interface according to a detected video-on-demand information viewing request.

The video-on-demand list corresponding to the live video may be a video-on-demand list obtained from a server and hidden in a set position of the live video playback interface when a user selects and plays a live video from a certain live station.

Optionally, the video-on-demand list may be a live program list to be played and having been played nearby a point-in-time of a current live video. Generally, each video recorded in the to-be-played video program list has already been stored in the server, and a user may play on demand a video in a video-on-demand playback interface when the user selects to view the video corresponding to the video program list.

Optionally, a playing order of live videos has been stored in the server in advance. In the live video playback interface, live videos would be played strictly according to time of a live program list, and cannot be played based on a user's independent choice. Therefore, the user is unable to directly view, in the live video playback interface, programs to be played and having been played nearby a point-in-time of the current live video. In related technologies, when a user wants to view and play a video, the user has to exit from the live video playback interface and search for the required video for playing in the video-on-demand playback interface. In the video-on-demand playback interface, the user may select a certain video program for playing based on the user's independent choice.

In this embodiment, optionally, a corresponding video-on-demand list can be provided for the user according to the user's video-on-demand information viewing request by jointly storing video-on-demand resources and live video resources in a same server and acquiring the video-on-demand list corresponding to the live video when the user is watching the live video.

A video may be conveniently and quickly searched and acquired by jointly storing the video-on-demand resources and the live video resources in a same server. However, in practical applications, the video-on-demand resources and the live video resources may also be stored in different servers or a server cluster composed of multiple servers, which is not limited in this embodiment.

In this embodiment, a display position of the video-on-demand list may be preset according to actual conditions, for example, the display position of the video-on-demand list may be positioned at a lower side or right side of the live video playback interface, which is not limited in this embodiment.

The video-on-demand information viewing request may be generated by triggering of a video remote controller. For example, a video-on-demand viewing request is generated by triggering when the user clicks a downward direction key of the video remote controller.

In Step 120, the live video playback interface is jumped to a video-on-demand playback interface corresponding to a target video item according to the target video item selected by the user from the video-on-demand list.

A video item in the video-on-demand list includes:

a video name and a video playback link corresponding to the video name; and/or

a video set name and a video set description page link corresponding to the video set name.

Jumping the live video playback interface to the video-on-demand playback interface corresponding to the target video item includes:

jumping the live video playback interface to a video playback link corresponding to the target video item according to the target video item selected by the user from the video-on-demand list, so as to play a video on-demand in the video-on-demand playback interface; or

jumping the live video playback interface to the video set description page link corresponding to the target video item according to the target video item selected by the user from the video-on-demand list, so as to display description information of a video-on-demand set in the video-on-demand playback interface.

Optionally, when a video item in the video-on-demand list is a video name, a video playback link corresponding to the video name can be entered by clicking and selecting the video name of the target video item, so that the video-on-demand playback interface can be entered to directly play the video corresponding to the video name.

Optionally, when a video item in the video-on-demand list is a video set name, a video set description page link corresponding to the video set name can be entered by clicking and selecting the video set name of the target video item, so that a video set description page can be displayed; where the video set description page displays detailed description corresponding to the video-on-demand set and video playback links corresponding to all videos included in the video set, so that the user may independently select and watch a video according to requirements.

According to the foregoing two different video items, there are different corresponding selection operations to the video items in the video-on-demand list, and video items are not limited to the two video items. Different video items correspond to different corresponding selection operations, which may be determined according to actual conditions. The video items may include the foregoing two video items or only include either one of the foregoing two video items, and the video items are not limited to the two video items, which may be set according to requirements.

In one example, when a live video currently watched by a user is: “the 26th episode of XX Series”, video items in the video-on-demand list corresponding to the live video may include “the 27th episode of XX Series” and a video playback link corresponding to the video name, or may further include “full episodes of XX Series” and a video description page link corresponding to the video set name (Optionally, a video playback link of each episode of the Series is recorded in the description page).

In the technical solution of this embodiment, in a playback process of a live video, a video-on-demand list corresponding to the live video is displayed in a live video playback interface according to a detected video-on-demand information viewing request; and the live video playback interface is jumped to a video-on-demand playback interface corresponding to the target video item according to the target video item selected by a user from the video-on-demand list. The technical solution of this embodiment can implement switching from the live video playback interface to the video-on-demand playback interface, facilitate a user to quickly enter the video-on-demand playback interface so as to click and play a video therein according to individual needs while watching a live video, thereby improving's autonomy of the user in watching videos.

On a basis of the foregoing solution, optionally, before Step 120, the method further includes: withdrawing the video-on-demand list in the live video playback interface when no selection operation of a user on the target video item in the video-on-demand list is detected within a preset time interval or a video-on-demand information withdrawing request is detected.

When a live video of a certain live station is played in the live video playback interface, the video-on-demand list may be hidden in a lower right corner of the live video playback interface, so as to avoid a problem that there is a negative effect on the user's watching since the video-on-demand list is present in the live video playback interface when a live video is played. If the user carelessly triggers the video remote controller instead of intentionally displays the video-on-demand list in the current live video playback interface, a time interval can be preset; and if the user does not select a target video item in the video-on-demand list within the preset time interval, the video-on-demand list can be withdrawn so that the user is not affected to watch a live video.

A setting button of the video remote controller may also be set as a button for withdrawing video-on-demand information. The video-on-demand list can be withdrawn when it is detected that the video remote controller triggers the button to send a video-on-demand information withdrawing request.

The foregoing two methods for withdrawing the video-on-demand list make it convenient to withdraw the video-on-demand list in the live video playback interface at any time without a negative effect on watching of a live video in the live video playback interface.

After Step 120, the method may further include: recording a live video link corresponding to the live video; and

jumping the video-on-demand playback interface to the live video link when a live video returning request is detected, so as to continue playing the live video.

Optionally, a certain button of the video remote controller may be set for returning to the live video playback interface. By pressing the button, the video-on-demand playback interface can be jumped to the live video link, so as to continue playing the live video being played when the live video playback interface is exited.

It can be returned from the video-on-demand playback interface to the live video playback interface by such setting, so that a user may continue watching the live video, thereby simplifying a switching operation of the user between a live video and a video on-demand and improving the user's autonomy.

Optionally, the video-on-demand information viewing request, the video-on-demand information withdrawing request or the live video returning request is generated by triggering of the video remote controller.

Optionally, the foregoing requests may be implemented by setting respective buttons of the video remote controller, so that corresponding request can be sent out by triggering corresponding button.

Optionally, a downward key of the video remote controller may be set for viewing video-on-demand information, and pressing twice on the downward key may be set for withdrawing the video-on-demand information, or pressing an upward key may also be set for withdrawing the video-on-demand information, or a return key and a home key may also be set for returning the live video playback interface. Corresponding relations between keys of the video remote controller and the foregoing requests are not limited here, which may be set according to requirements.

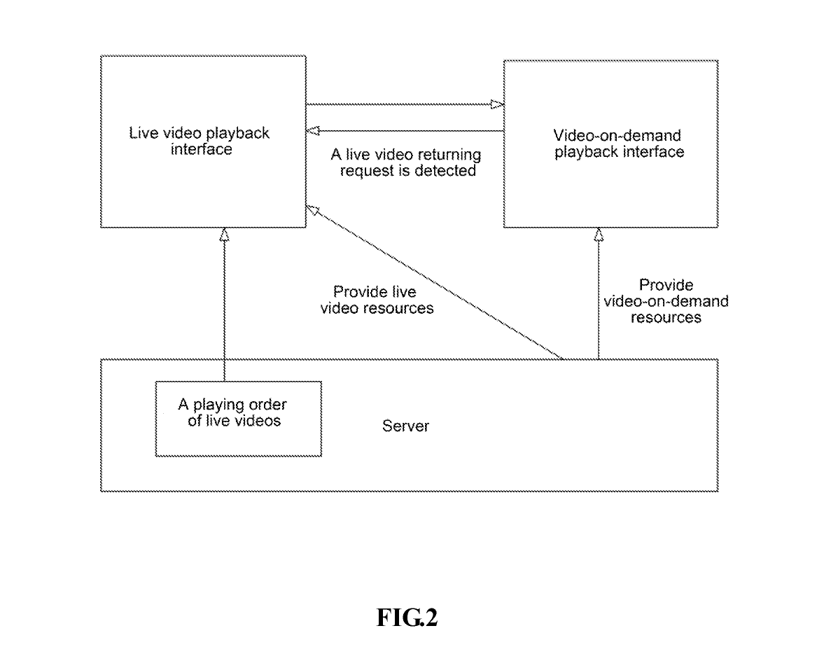

Optionally, FIG. 2 is a diagram showing an execution process of a method for switching video according to Embodiment I of the present disclosure, as shown in FIG. 2, live video resources and video-on-demand resources are jointly stored in a server; a playing order of live videos is stored in the server in advance; in the live video playback interface, live videos are played according to the playing order of live videos, in a playback process of a live video, a video-on-demand list corresponding to the live video would be displayed in a live video playback interface when a video-on-demand information viewing request is detected; the live video playback interface is jumped to a video-on-demand playback interface corresponding to the user's selection by selecting a target video item in the video-on-demand list, a video is independently selected and watched according to the user's requirements; and when a live video returning request is detected, the video-on-demand playback interface is jumped to the live video link to continue playing the live video.

The execution process of the method for switching video provided by the foregoing embodiments can implement mutual switching between the live video playback interface and the video-on-demand playback interface, facilitate a user to quickly enter the video-on-demand playback interface according to individual needs while watching a live video so as to independently select and play a video therein, and to jump from the video-on-demand playback interface to the live video playback interface when a live video returning request is detected, thereby improving the user's autonomy in watching videos.

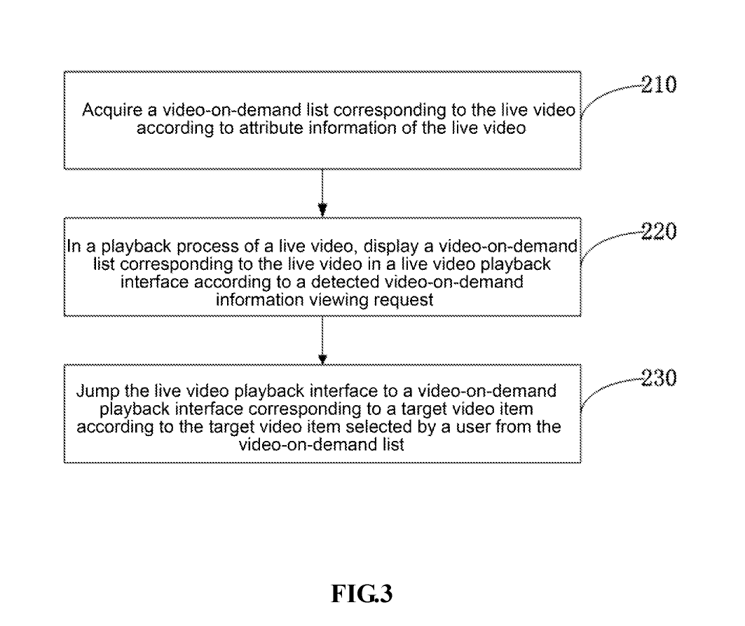

FIG. 3 is a flowchart showing a method for switching video according to Embodiment II of the present disclosure, and the method includes following steps.

In Step 210, a video-on-demand list corresponding to the live video is acquired according to attribute information of the live video.

Optionally, the video-on-demand list is obtained from a server and is hidden in a set position of the live video playback interface when it is switched to a live video of a certain live station.

The attribute information of the live video includes at least one of the following:

video type information, video name information, video director information, video actor information, video definition information, video duration information and live program information corresponding to the live video.

When attribute information of a live video is different, an acquired video-on-demand list corresponding to the live video is also different.

Optionally, for example, when the attribute information of the live video is live program list information corresponding to the live video, the video-on-demand list may be a live program list to be played and having been played nearby a point-in-time of a current live video.

The attribute information of the live video also may be video actor information related to the current live video. For example, when the current live video is Empresses in the Palace, the video-on-demand list may include different actors' names of Empresses in the Palace; and by clicking an actor's name, links of all programs that the actor participated in can be entered for the user's choice.

In Step 220, in a playback process of a live video, a video-on-demand list corresponding to the live video is displayed in a live video playback interface according to a detected video-on-demand information viewing request; and

in Step 230, the live video playback interface is jumped to a video-on-demand playback interface corresponding to a target video item according to the target video item selected by a user from the video-on-demand list.

In the technical solution of this embodiment, a video-on-demand list corresponding to the live video is acquired according to attribute information of the live video; in a playback process of the live video, the video-on-demand list corresponding to the live video is displayed in a live video playback interface according to a detected video-on-demand information viewing request; and the live video playback interface is jumped to a video-on-demand playback interface corresponding to the target video item according to the target video item selected by a user from the video-on-demand list. The technical solution of this embodiment can achieve acquiring of the video-on-demand list corresponding to the live video in the live video playback interface according to attribute information of the live video, and different video-on-demand lists can be acquired according to different attribute information of the live video, so that diversity of the user's selection can be increased, and user experience can be enriched.

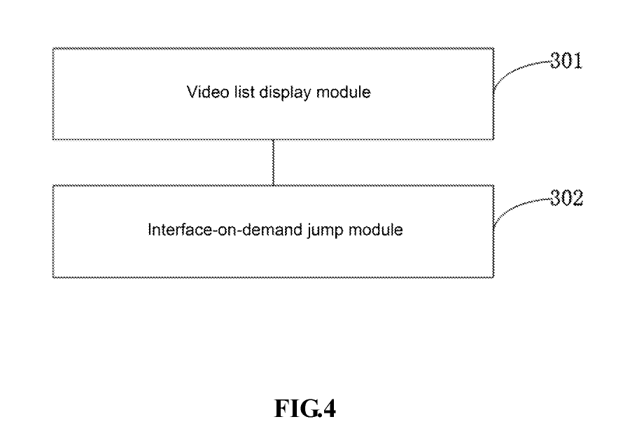

FIG. 4 is a structural diagram showing an device for switching video according to Embodiment III of the present disclosure, referring to FIG. 4, a structure based on the device for switching video includes:

a video list display module 301, which is configured to display, in a playback process of a live video, a video-on-demand list corresponding to the live video in a live video playback interface according to a detected video-on-demand information viewing request; and

an interface-on-demand jump module 302, which is configured to jump the live video playback interface to a video-on-demand playback interface corresponding to a target video item according to the target video item selected by a user from the video-on-demand list.

In the technical solution of this embodiment, in a playback process of a live video by means of the video list display module in the device for switching video, a video-on-demand list corresponding to the live video is displayed in a live video playback interface according to a detected video-on-demand information viewing request; and the live video playback interface is jumped by the interface-on-demand jump module to a video-on-demand playback interface corresponding to the target video item according to the target video item selected by a user from the video-on-demand list. The technical solution of this embodiment can implement switching from the live video playback interface to the video-on-demand playback interface, facilitate a user to quickly enter the video-on-demand playback interface according to individual needs while watching a live video, so as to click and play a video therein, thereby improving the user's autonomy in watching videos.

On a basis of the foregoing embodiments, the device may further include:

a video list acquiring module, which is configured to acquire the video-on-demand list corresponding to the live video according to attribute information of the live video before displaying, in a playback process of a live video, the video-on-demand list corresponding to the live video in a live video playback interface according to a detected video-on-demand information viewing request;

the attribute information of the live video includes at least one of the following:

video type information, video name information, video director information, video actor information, video definition information, video duration information and live program information corresponding to the live video.

On a basis of the foregoing embodiments, a video item in the video-on-demand list may include: a video name and a video playback link corresponding to the video name; and/or

a video set name and a video set description page link corresponding to the video set name;

where the interface-on-demand jump module 302 includes:

a video-on-demand playing unit, which is configured to jump the live video playback interface to a video playback link corresponding to the target video item according to an selection operation of a user on the target video item in the video-on-demand list, so as to play a video on-demand in the video-on-demand playback interface; or

a video-on-demand set display unit, which is configured to jump the live video playback interface to the video set description page link corresponding to the target video item according to selection operations by a user on the target video item in the video-on-demand list, so as to display description information of a video-on-demand set in the video-on-demand playback interface.

On a basis of the foregoing embodiments, the device may further include: a video list withdrawing module, which is configured to withdraw the video-on-demand list in the live video playback interface before the live video playback interface is jumped to a video-on-demand playback interface corresponding to the target video item when no selection operation of a user on the target video item in the video-on-demand list is detected within a preset time interval or a video-on-demand information withdrawing request is detected.

On a basis of the foregoing embodiments, the device may further include: a live video link recording module, which is configured to record a live video link corresponding to the live video after the live video playback interface is jumped to a video-on-demand playback interface corresponding to the target video item according to the target video item selected by a user from the video-on-demand list; and

a live video playing module, which is configured to jump the video-on-demand playback interface to the live video link when a live video returning request is detected, so as to continue playing the live video.

On a basis of the foregoing embodiments, the video-on-demand information viewing request, the video-on-demand information withdrawing request or the live video returning request may be generated by triggering of the video remote controller.

The foregoing products can execute the method provided by any embodiment of the present disclosure, and have corresponding functional modules for executing the method.

Embodiments of the present disclosure provide a non-transitory computer storage medium storing computer-executable instructions, which can execute the method for switching video according to any of the foregoing method embodiments.

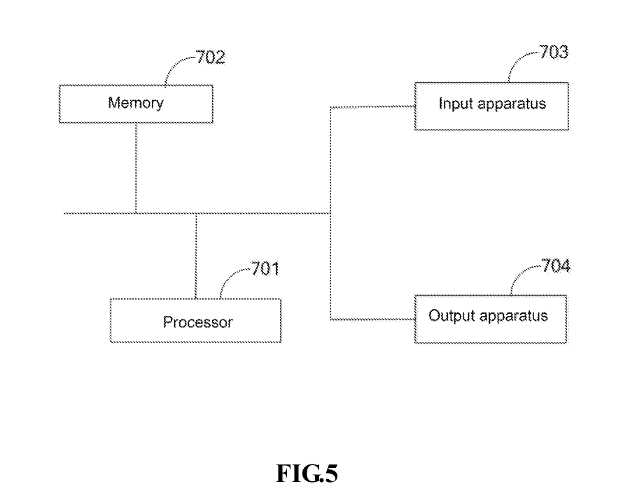

FIG. 5 is a functional block diagram showing a hardware structure of a device for executing the method for switching video according to Embodiment V of the present disclosure, as shown in FIG. 5, the device includes:

At least one processor 701 and a memory 702, where one processor 701 is taken as an example in FIG. 5.

The device may further include: an input device 703 and an output device 704.

The processor 701, the memory 702, the input device 703 and the output device 704 in the device may be connected by means of a bus or in other ways; where a connection by means of a bus is taken as an example in FIG. 5.

As a non-transitory computer readable storage medium, the memory 702 may be configured to store non-transitory software programs, non-transitory computer executable programs and modules such as program instructions/modules (for example, the video list display module 301 and the interface-on-demand jump module 302 as shown in FIG. 4) corresponding to the method for switching video in embodiments of the present disclosure. The processor 701 may execute various function applications and data processing of a server, namely implement the method for switching video in the foregoing method embodiments, by running the non-transitory software programs, instructions and modules stored in the memory 702.

The memory 702 may include a program storage area and a data storage area, where the program storage area may store an operating system, application programs required for at least one function; and the data storage area may store data created according to use of a terminal device. Besides, the memory 702 may include a high speed random access memory, and may further include a non-transitory memory, such as at least one magnetic disk storage device, a flash memory, or other non-transitory solid-state storage devices. In some embodiments, the memory 702 may optionally include some memories remotely disposed relative to the processor 701, and these remote memories may be connected to a terminal device via a network. Instances of the foregoing network includes but is not limited to an Internet, an Intranet, a local area network (LAN), a mobile communication network and a combination thereof.

The input device 703 may be configured to receive input numerical or character information, and generate key signal input associated with user settings and function control of a terminal. The output device 704 may include a display device such as a display screen.

The at least one module is stored in the memory 702; and when it is executed by the at least one processor 701, the method for switching video in any of the foregoing method embodiments is executed.

The foregoing products may execute the method provided by embodiments of the present disclosure, and have corresponding functional modules for executing the method and beneficial effects. Reference is made to the method provided by embodiments of the present disclosure for technical details not elaborated in this embodiment.

The electronic device in embodiments of this application exists in various forms, including but not limited to:

(1) mobile telecommunication device. A device of this kind has a feature of mobile communicating function, and has a main object of providing voice and data communication. Devices of this kind include smart phone (such as iPhone), multi-media cell phone, functional cell phone, low-end cell phone and the like;

(2) ultra mobile personal computer device. A device of this kind belongs to a category of personal computer, has functions of computing and processing, and generally has a feature of mobile internet access. Devices of this kind include PDA, MID, UMPC devices and the like, such as ipad;

(3) portable entertainment device. A device of this kind can display and play multi-media content. Devices of this kind include audio and video player (such as ipod), handheld game player, e-book, intelligent toy and portable vehicle navigation device;

(4) server, which is a device providing computing services. Construction of a server includes a processor, a hard disk, a memory, a system bus and the like. The server is similar to a common computer in architecture, but has high requirements in aspects of processing capacity, stability, reliability, security, expandability, manageability and the like since services of high reliability are needed to be provided;

(5) other electronic device having data interacting functions.

Device embodiments described above are only illustrative, elements in the device embodiments illustrated as separated components may be or may not be physically separated, and components shown as elements may be or may not be physical elements, that is, the components may be located in one position, or may be distributed on a plurality of network units. Part or all of modules in the components may be selected according to actual requirements to achieve purpose of solutions in embodiments, which can be understood and perform by those of ordinary skill in the art without inventive works.

By descriptions of above embodiments, those skilled in the art can clearly learn that various embodiments can be achieved with aid of software and necessary common hardware platform, or with aid of hardware. Based on such an understanding, essential of above technical solutions or, in other words, parts of above technical solutions contributing to the related art may be embodied in form of software products which can be stored in a computer readable storage medium, such as a ROM/RAM, a disk, an optical disk and the like, and include a number of instructions configured to make a computer device (may be a personal computer, server, network device and the like) execute methods of various embodiments or parts of embodiments.

Finally, it should be noted that above embodiments are only used for illustrating but not to limit technical solutions of the present disclosure; although the present disclosure is described in detail with reference to the foregoing embodiments, those of ordinary skill in the art should understand that technical solutions recorded in the foregoing embodiments can be modified, or parts of the technical solutions can be equally replaced; and the modification and replacement dose not make essential of corresponding technical solutions depart from spirits and scope of technical solutions of various embodiments.

What is claimed is:

1. A method for switching video, comprising:
displaying, in a playback process of a live video, a video-on-demand list corresponding to the live video in a live video playback interface according to a detected video-on-demand information viewing request; and
jumping the live video playback interface to a video-on-demand playback interface corresponding to a target video item according to the target video item selected by a user from the video-on-demand list.

2. The method according to claim 1, before displaying a video-on-demand list corresponding to the live video in a live video playback interface, further comprising:
acquiring the video-on-demand list corresponding to the live video according to attribute information of the live video,
wherein the attribute information of the live video includes at least one of the following:
video type information, video name information, video director information, video actor information, video definition information, video duration information and live program information corresponding to the live video.

3. The method according to claim 1,
wherein a video item in the video-on-demand list comprises: a video name and a video playback link corresponding to the video name; and
wherein the jumping the live video playback interface to a video-on-demand playback interface corresponding to the target video item comprises:
jumping the live video playback interface to a video playback link corresponding to the target video item according to the target video item selected by a user from the video-on-demand list, so as to play a video on-demand in the video-on-demand playback interface.

4. The method according to claim 1, wherein a video item in the video-on-demand list comprises:
a video set name and a video set description page link corresponding to the video set name;
the jumping the live video playback interface to a video-on-demand playback interface corresponding to the target video item comprises:
jumping the live video playback interface to the video set description page link corresponding to the target video item according to the target video item selected by a user from the video-on-demand list, so as to display description information of a video-on-demand set in the video-on-demand playback interface.

5. The method according to claim 1, before jumping the live video playback interface to a video-on-demand playback interface corresponding to the target video item, further comprising:
withdrawing the video-on-demand list in the live video playback interface when no selection operation of a user on the target video item in the video-on-demand list is detected within a preset time interval or a video-on-demand information withdrawing request is detected.

6. The method according to claim 1, after jumping the live video playback interface to a video-on-demand playback interface corresponding to the target video item according to the target video item selected by a user from the video-on-demand list, further comprising:
recording a live video link corresponding to the live video; and
jumping the video-on-demand playback interface to the live video link when a live video returning request is detected, so as to continue playing the live video.

7. An electronic device for switching video, comprising:
at least one processor; and
a memory communicably connected with the at least one processor for storing instructions executable by the at least one processor, wherein execution of the instructions by the at least one processor causes the at least one processor to:
display, in a playback process of a live video, a video-on-demand list corresponding to the live video in a live video playback interface according to a detected video-on-demand information viewing request, and
jump the live video playback interface to a video-on-demand playback interface corresponding to a target video item according to the target video item selected by a user from the video-on-demand lists.

8. The electronic device according to claim 7,
wherein, the execution of the instructions by the at least one processor further causes the at least one processor to:
acquire the video-on-demand list corresponding to the live video according to attribute information of the live video before displaying, in a playback process of a live video, the video-on-demand list corresponding to the live video in a live video playback interface according to a detected video-on-demand information viewing request, and
wherein the attribute information of the live video includes at least one of the following:
video type information, video name information, video director information, video actor information, video definition information, video duration information and live program information corresponding to the live video.

9. The electronic device according to claim 7,
wherein a video item in the video-on-demand list comprises: a video name and a video playback link corresponding to the video name, and
wherein the execution of the instructions by the at least one processor causes the at least one processor to:
jump the live video playback interface to a video playback link corresponding to the target video item according to an selection operation of a user on the target video item in the video-on-demand list, so as to play a video on-demand in the video-on-demand playback interface.

10. The electronic device according to claim 7,
wherein a video item in the video-on-demand list comprises: a video set name and a video set description page link corresponding to the video set name, and
wherein the execution of the instructions by the at least one processor causes the at least one processor to:
jump the live video playback interface to the video set description page link corresponding to the target video item according to selection operations by a user on the target video item in the video-on-demand list, so as to display description information of a video-on-demand set in the video-on-demand playback interface.

11. The electronic device according to claim 7, wherein, the execution of the instructions by the at least one processor further causes the at least one processor to: withdraw the video-on-demand list in the live video playback interface before the live video playback interface is jumped to a video-on-demand playback interface corresponding to the target video item when no selection operation of a user on the target video item in the video-on-demand list is detected within a preset time interval or a video-on-demand information withdrawing request is detected.

12. The electronic device according to claim 7, wherein, the execution of the instructions by the at least one processor further causes the at least one processor to:
record a live video link corresponding to the live video after the live video playback interface is jumped to a video-on-demand playback interface corresponding to the target video item according to the target video item selected by a user from the video-on-demand list; and
jump the video-on-demand playback interface to the live video link when a live video returning request is detected, so as to continue playing the live video.

13. A non-transitory computer-readable storage medium storing executable instructions that, when executed by an electronic device, cause the electronic device to:
display, in a playback process of a live video, a video-on-demand list corresponding to the live video in a live video playback interface according to a detected video-on-demand information viewing request; and
jump the live video playback interface to a video-on-demand playback interface corresponding to a target video item according to the target video item selected by a user from the video-on-demand list.

14. The non-transitory computer-readable storage medium according to claim 13, before displaying a video-on-demand list corresponding to the live video in a live video playback interface, the executable instructions further cause the electronic device to:
acquire the video-on-demand list corresponding to the live video according to attribute information of the live video,
wherein the attribute information of the live video includes at least one of the following:
video type information, video name information, video director information, video actor information, video definition information, video duration information and live program information corresponding to the live video.

15. The non-transitory computer-readable storage medium according to claim 13,
wherein a video item in the video-on-demand list comprises: a video name and a video playback link corresponding to the video name, and
wherein when jumping the live video playback interface to a video-on-demand playback interface corresponding to the target video item, the executable instructions cause the electronic device to:
jump the live video playback interface to a video playback link corresponding to the target video item according to the target video item selected by a user from the video-on-demand list, so as to play a video on-demand in the video-on-demand playback interface.

16. The non-transitory computer-readable storage medium according to claim 13, wherein a video item in the video-on-demand list comprises: a video set name and a video set description page link corresponding to the video set name;
when jumping the live video playback interface to a video-on-demand playback interface corresponding to the target video item, the executable instructions cause the electronic device to:
jump the live video playback interface to the video set description page link corresponding to the target video item according to the target video item selected by a user from the video-on-demand list, so as to display description information of a video-on-demand set in the video-on-demand playback interface.

17. The non-transitory computer-readable storage medium according to claim 13, before jumping the live video playback interface to a video-on-demand playback interface corresponding to the target video item, the executable instructions further cause the electronic device to:
withdraw the video-on-demand list in the live video playback interface when no selection operation of a user on the target video item in the video-on-demand list is detected within a preset time interval or a video-on-demand information withdrawing request is detected.

18. The non-transitory computer-readable storage medium according to claim 13, after jumping the live video playback interface to a video-on-demand playback interface corresponding to the target video item according to the target video item selected by a user from the video-on-demand list, the executable instructions further cause the electronic device to:
record a live video link corresponding to the live video; and
jump the video-on-demand playback interface to the live video link when a live video returning request is detected, so as to continue playing the live video.
